(19) United States
(12) Patent Application Publication
(10) Pub. No.: US 2015/0308669 A1
(43) Pub. Date: Oct. 29, 2015

(54) ENVIRONMENTALLY FRIENDLY FLEXIBLE ILLUMINATING DEVICE

(71) Applicant: Ronald Albert Moreno, City of Industry, CA (US)

(72) Inventor: Ronald Albert Moreno, City of Industry, CA (US)

(21) Appl. No.: 14/691,853

(22) Filed: Apr. 21, 2015

Related U.S. Application Data
(60) Provisional application No. 61/995,908, filed on Apr. 23, 2014.

(51) Int. Cl. F21V 23/00; F21V 23/04; F21S 4/00; F21V 31/00; F21V 21/092; F21V 7/00; F21L 4/00

(52) U.S. Cl. CPC F21V 23/003; F21V 7/0066; F21V 23/04; F21L 4/00; F21V 31/005; F21V 21/0925; F21S 4/005; F21Y 2103/003

(57) ABSTRACT

An environmentally friendly illuminating device produces a brilliant light for signaling, directing traffic, illuminating an area, or drawing attention to an event. The device includes a shock resistant and water proof tube that enables passage of both steady and alternating light patterns from a flexible strip of light emitting diodes (LED). By utilizing a battery powered LED, spontaneous chemical reactions are not necessitated for generating the illumination. For example, toxins, smoke, fire, and excessive heat are not emitted. An opaque, flexible tube bends to facilitate stowage. An LED strip provides about 360 lumens of illumination. A reflector cap partially scatters the light. A distal cap and a proximal cap form water tight seals over the ends of the tube. An outer grip is foam to provide good control. A battery housing is watertight to protect the battery power source. A control portion controls power and alternates between lighting patterns.

### CROSS-REFERENCE TO RELATED APPLICATIONS

This Non-Provisional Patent Application claims priority from the Provisional Patent Application No. 61/995,908.

### FIELD OF THE INVENTION

The present invention relates generally to an environmentally friendly flexible illuminating device. More so, an environmentally friendly illuminating device produces a brilliant light for signaling, directing traffic, illuminating an area, or drawing attention to an event through a shock resistant and water proof tube that enables passage of both steady and alternating light patterns from a flexible strip of light emitting diodes (LED) without necessitating spontaneous chemical reactions that emit toxins, smoke, and excessive heat.

### BACKGROUND OF THE INVENTION

Typically, a flare is a self-powered illuminating device. Specifically, the flare is a type of pyrotechnic that produces a brilliant light or intense heat without creating an explosion. Flares are used for signaling, illumination, or defensive countermeasures in civilian and military applications. Flares provide maximum illumination time over a large area.

A light emitting diode (LED) is a two-lead semiconductor light source. It is a pn-junction diode, which emits light when activated. When a suitable voltage is applied to the leads, electrons are able to recombine with electron holes within the device, releasing energy in the form of photons. This effect is called electroluminescence, and the color of the light that corresponds to the energy of the photon is determined by the energy band gap of the semiconductor. The LED creates a wide variety of colors and can be configured to generate various synchronized patterns.

In many instances, flares are used as temporary signals to mark the location of road hazards such as construction, accidents, other emergency operations and the like or just to provide a temporary warning or to call notice to some given situation. Generally, emergency response personnel often use road flares to help in this matter.

It is known that, while such flares are certainly bright enough, they do suffer from several disadvantages. First, they are generally very rigid. This is problematic for stowage and portability of the flare. Secondly, the flares creates the illumination through a spontaneous chemical reaction that generates smoke, toxins, and heat. Thirdly, flares, which use pyrotechnic mechanisms to illuminate become ineffective if damp.

Other proposals have involved flares for signaling, illuminating a roadway, or providing guidance at an event. The problem with these devices is that they are not flexible, environmentally friendly, or sealed from moisture.

Thus, an unaddressed need exists in the industry to address the aforementioned deficiencies and inadequacies. Even though the above cited methods for flares meets some of the needs of the market, an environmentally friendly illuminating device that bends for stowage, does not generate toxins or smoke, and inhibits moisture and dust from entering the illumination generating components is still desired.

### SUMMARY OF THE INVENTION

The present invention is directed to an environmentally friendly illuminating device produces a brilliant light for signaling, directing traffic, illuminating an area, or drawing attention to an event through a shock resistant and water proof tube. The tube enables passage of both steady and alternating light patterns from a flexible light emitting diodes (LED) strip; whereby spontaneous chemical reactions that emit toxins, smoke, and excessive heat are generally not generated. The tube also inhibits moisture and dust from entering to damage the LED and electrical components.

The illuminating device, hereafter, “device”, is sufficiently flexible, such that stowage and portability are more easily performed, as the device can bend and conform to a desired shape and possible damage form a rigid disposition is minimized. However, the flexible characteristics of the device still allow for a shock resistant, waterproof configuration that protects an interior LED from damage. Further, by utilizing a battery powered LED, spontaneous chemical reactions are not necessitated for generating the illumination. For example, toxins, smoke, fire, and excessive heat are not emitted.

In some embodiments, the device comprises a generally elongated, flexible tube. The flexible tube forms a substantial part of the housing of the device, protecting the inner electronic and lighting components. The tube is generally opaque, so as to allow light to pass through. In one alterative embodiments, the tube may be coated with a colored film or composition to alter the color of the light passing through. An outer grip encapsulates at least a portion of the tube to enable secure control and grasping of the device. The ends of the tube include control switches, a flexible stand, and a reflector cap, and a pair of water tight sealed caps.

In some embodiments, an LED strip is securely positioned inside the tube. The LED illuminates through a two lead semiconductor mechanism that emits the light when activated. In some embodiments, the LED may generate both steady and alternating light patterns. The LED is secured concentrically and padded against the inner surface of the tube, so as to inhibit breakage of the individual lenses in the LED. A distal cap may form at one end of the tube. The distal cap may include a rubberized foam that further enhances the shock resistant characteristics of the device. The distal cap may also be fluorescent, so as to draw attention to the device in conjunction with the light from the LED.

In some embodiments, a reflector cap is disposed inside the tube, and adjacent to the distal cap. The reflector cap is effective for scattering the light that is generated by the LED. The device is powered by a battery. The battery provides efficient energy for powering the LED without the need for spontaneous chemical reactions, as are found in flares known in the art. A battery housing inside the tube is sized and dimensioned to securely contain the battery.

In some embodiments, a proximal cap forms a terminus at the proximal end of the tube. The proximal cap forms a water tight seal to inhibit moisture from entering the tube and damaging the LED and battery. A control portion positions at the proximal cap, such that operation is facilitated. The control portion includes a power switch and a lighting switch that operatively connect to the LED and the battery through a circuitry. The power switch is configured to power on and off the LED. The lighting switch is configured to control the LED, such that both steady and alternating light patterns are generated.

In some embodiments, a flexible stand attaches to the proximal cap to hold the device in an upright position. The flexible stand has a base that rests on a mounting surface. The base may adhere to the mounting surface through a suction, an adhesive, or a magnet. In this manner, the device may be attached to a vertical wall. The flexible stand further includes a sleeve that receives the proximal cap and a portion of the tube. The sleeve is sufficiently flexible, such that the tube can sway while affixed to a mounting surface.

One objective of the present invention is to provide a flexible illuminating device that at least partially bends and conforms for stowage and controllable illumination of light.

Another objective is to provide a flexible illuminating device with an LED that generates a high amount of lumens and switches between a steady and an alternating pattern of lighting.

Another objective is to provide a flexible illuminating device that generates lighting without necessitating spontaneous chemical reactions that emit toxins, smoke, and excessive heat.

Another objective is to provide a flexible illuminating device with a waterproof and shock resistant tube.

Another objective is to provide a flexible illuminating device that is easily gripped by a foam outer grip.

Yet another objective is to provide a temporary light signal to mark the location of road hazards such as construction, accidents, and emergency operations.

Yet another objective is to provide a temporary warning or to call notice to an event.

Yet another objective is to protect the battery in a secure, waterproof battery housing.

Yet another objective is to provide cost effective illuminating device that is easy to operate.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a top perspective view of an exemplary flexible illuminating device and an exemplary flexible stand, in accordance with an embodiment of the present invention;

FIG. 2 illustrates a blow up view of the flexible illuminating device, in accordance with an embodiment of the present invention;

FIG. 3 illustrates a perspective view of the flexible illuminating device in an upright position supported by the flexible stand, in accordance with an embodiment of the present invention; and

FIG. 4 illustrates a perspective view of the flexible illuminating device with the flexible stand detached, in accordance with an embodiment of the present invention.

Like reference numerals refer to like parts throughout the various views of the drawings.

### DETAILED DESCRIPTION OF THE INVENTION

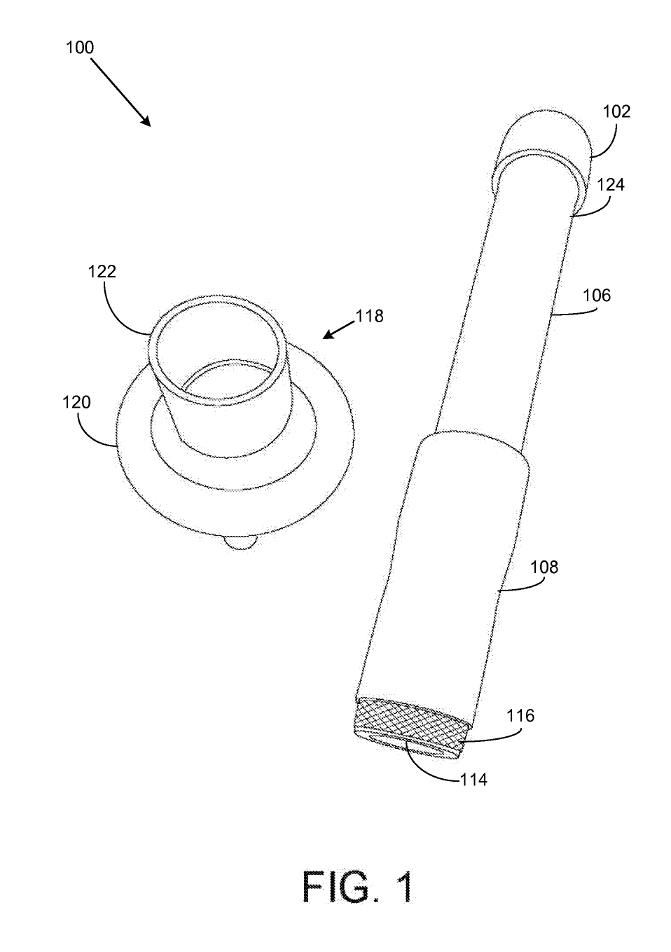

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

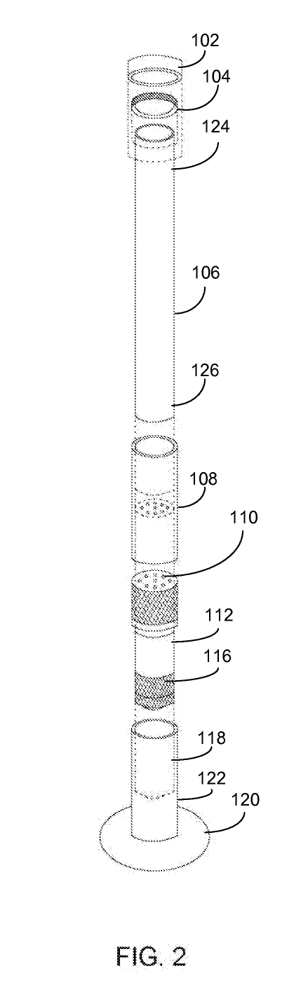

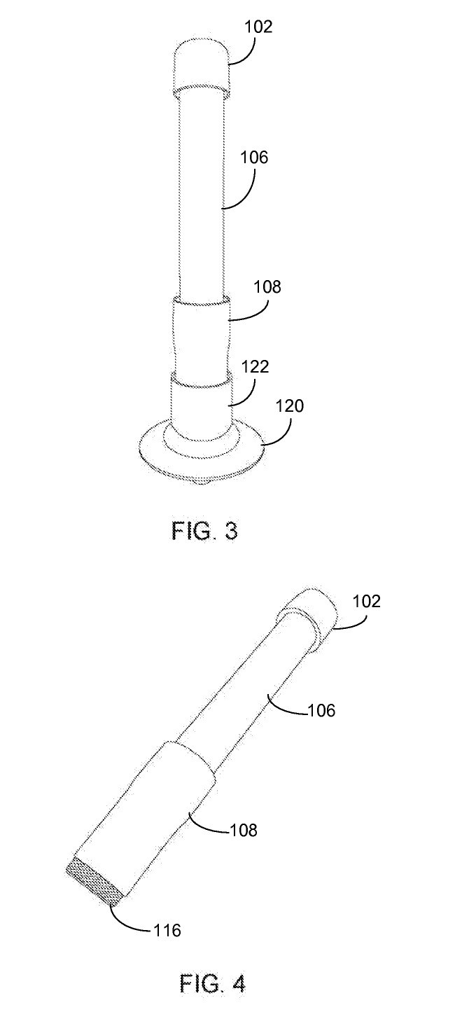

In one embodiment of the present invention presented in FIGS. 1-4, an environmentally friendly illuminating device 100, hereafter, “device 100” produces a brilliant light for signaling, directing traffic, illuminating an area, or drawing attention to an event. For example, traffic may be directed at night with the device 100. The device 100 includes a shock resistant and water proof tube 106 that enables passage of both steady and alternating light patterns from an internally disposed light emitting diode (LED) strip 110. By utilizing a battery powered LED strip 110, spontaneous chemical reactions are not formed for generation of the illumination. For example, toxins, smoke, fire, and excessive heat are not emitted by the (LED) strip 110.

The tube 106 is generally opaque and flexible. The tube 106 at least partially bends to facilitate stowage and minimize damage. An LED strip 110 is securely retained inside the tube 106. A reflector cap 104 partially scatters the light. A distal cap 102 and a proximal cap 116 form water tight seals over the ends of the tube 106. An outer grip 108 is fabricated from foam to provide a comfortable grip that allows efficient control of the device 100. An inner surface of the outer grip 108 is rigid and generally indestructible, so as to provide additional protection to a battery housing 112 located within. The battery housing 112 contains the battery power source, and is watertight to protect the battery power source. A control portion 114 controls power, and alternates between lighting patterns in the LED strip 110. In one possible embodiment, the device 100 is about 10.75 inches long, and has a 1.5 inch diameter. The device 100 may also weigh about 8 ounces.

The device 100 is sufficiently flexible, such that stowage and portability are more easily performed, and possible damage form a rigid disposition is minimized. This is because the device 100 can at least partially bend and conform to a desired shape. The flexible characteristics of the device 100 create a shock resistant, waterproof configuration that protects the interior LED strip 110 from damage. Further, by utilizing a battery powered LED strip 110, spontaneous chemical reactions are not necessitated for generating the illumination. For example, toxins, smoke, fire, and excessive heat are not emitted.

In some embodiments, the flexible tube 106 forms a substantial part of the housing for the device 100, protecting the internally disposed LED strip 110 and electronic components. The tube 106 may be opaque and have a polyvinyl chloride material composition. However, other flexible materials may be used. In one embodiment, the tube 106 allows most of the light to pass through. In one alterative embodiments, the tube 106 may be coated with a colored film or composition to alter the color of the light passing through.

In some embodiments, an LED strip 110 is securely positioned inside the tube 106. The LED strip 110 illuminates through a two lead semiconductor mechanism that emits the light when activated. A voltage is applied across the leads to generate the illumination. In some embodiments, the LED strip 110 may generate both steady and alternating light patterns. In one embodiment, the alternating lighting pattern is a flashing red light. Though any pattern of synchronization and color may be used.

The LED strip 110 is secured concentrically and padded against the inner surface of the tube 106, so as to inhibit breakage of the individual lenses in the LED strip 110. In one possible embodiment, the LED strip 110 comprises 12 one Watt light emitting diode lamps. The 12 one Watt light emitting diode lamps are configured to generate about 360 lumens and a brightness between 11000 mcd to 13000 mcd.

A distal cap 102 may form at one end of the tube 106. The distal cap 102 may have rounded corners to avoid snagging. The distal cap 102 may include a rubberized foam that further enhances the shock resistant characteristics of the device 100. The distal cap 102 may also have a fluorescent color, so as to draw attention to the device 100 in conjunction with the light from the LED. The distal cap 102 may include a hole. The hole is configured to enable the device 100 to receive a hook or bar for hanging.

In some embodiments, a reflector cap 104 is disposed inside the tube 106, and adjacent to the distal cap 102. The reflector cap 104 is effective for scattering the light that is generated by the LED strip 110. In one embodiment, the reflector cap 104 is a flexible disc of aluminum. The device 100 is powered by a battery. In one embodiment, the battery comprises thee AAA batteries. The battery provides efficient energy for powering the LED strip 110 without the need for spontaneous chemical reactions, as are found in flares known in the art. A battery housing 112 inside the tube 106 is sized and dimensioned to securely contain the battery. The battery housing 112 may include an aluminum alloy material composition that is waterproof and resists oxidation.

In some embodiments, a proximal cap 116 forms a terminus at the proximal end of the tube 106. The proximal cap 116 forms a water tight seal to inhibit moisture from entering the tube 106 and damaging the LED strip 110 and battery. A control portion 114 positions at the proximal cap 116, such that operation is facilitated. The control portion 114 includes a power switch and a lighting switch that operatively connect to the LED strip 110 and the battery through a circuitry. The power switch is configured to power on and off the LED strip 110. The lighting switch is configured to control the LED strip 110, such that both steady and alternating light patterns are generated. In another embodiment, the lighting switch is configured to enable alternating of the lighting patterns between three different colors. In one embodiment, the switches are toggle switches.

In some embodiments, an outer grip 108 encapsulates at least a portion of the tube 106 to enable secure control and grasping of the device 100. The outer grip 108 may include a foam composition material. The foam provides a comfortable, secure grip for controlling the device 100. Those skilled in the art will recognize that directing traffic often requires many hours of holding the device 100. Thus, the foam composition facilities this operation. An inner surface of the outer grip 108 is rigid and generally indestructible, so as to provide additional protection to a battery housing 112 located within. In one embodiment, the inner surface is steel. The inner surface may further include a threaded terminus area to threadably attach and detach the battery housing 112.

In some embodiments, a flexible stand 118 attaches to the proximal cap 116 to hold the device 100 in an upright position. The flexible stand 118 has a base 120 that rests on a mounting surface. The base 120 may adhere to the mounting surface through a suction cup, an adhesive, or a magnet. In this manner, the device 100 may be attached to a vertical wall. The flexible stand 118 further includes a sleeve 122 that receives the proximal cap 116 and a portion of the tube 106. The sleeve 122 is sufficiently flexible, such that the tube 106 can sway while affixed to a mounting surface. Suitable materials for the flexible stand 118 may include, without limitation, rubber, polyvinyl chloride, a flexible polymer and wood. The flexible stand 118 is optional.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A flexible illumination device for environmentally friendly signaling, the device comprising:
a light emitting diode strip, the light emitting diode strip configured to selectively illuminate in a steady lighting pattern and an alternating lighting pattern;
a generally elongated tube, the tube defined by a distal end and a proximal end, the tube configured to encapsulate the light emitting diode strip, the tube further configured to enable the lighting patterns from the light emitting diode strip to at least partially pass through, the tube further configured to at least partially bend;
a reflector cap, the reflector cap configured to at least partially scatter the lighting patterns;
a battery housing, the battery housing configured to contain a battery, the battery housing further configured to restrict moisture from engaging the battery;
a distal cap, the distal cap disposed to cover the distal end of the tube, the distal cap comprising a foam composition, the distal cap further configured to form a water tight seal over the distal end of the tube;
a proximal cap, the proximal cap disposed to cover the proximal end of the tube, the proximal cap further configured to form a water tight seal over the proximal end of the tube;
a control portion, the control portion configured to operatively connect to the light emitting diode strip and the battery, the control portion comprising a power switch and a lighting switch, the power switch configured to power on and power off the light emitting diode switch, the lighting switch configured to selectively alternate between the steady lighting pattern and the alternating lighting pattern; and
an outer grip, the outer grip configured to at least partially wrap around a portion of the tube, the outer grip configured to facilitate gripping the device.

2. The device of claim 1, wherein the device is a flare.

3. The device of claim 1, wherein the device is about 10.75 inches long, and has a 1.5 inch diameter.

4. The device of claim 1, wherein the device is about 8 ounces.

5. The device of claim 1, wherein the light emitting diode strip comprises 12 one Watt light emitting diode lamps.

6. The device of claim 5, wherein the 12 one Watt light emitting diode lamps generate 360 lumens and a brightness between 11000 mcd to 13000 mcd.

7. The device of claim 1, wherein the alternating lighting pattern is a flashing red light.

8. The device of claim 1, wherein the reflector cap is flexible aluminum.

9. The device of claim 1, wherein the tube is fabricated from an opaque, polyvinyl chloride material.

10. The device of claim 1, wherein the tube is shock resistant and waterproof.

11. The device of claim 1, wherein the outer grip is made of a foam material.

12. The device of claim 1, wherein the distal cap forms a water tight seal at the distal end of the tube.

13. The device of claim 1, wherein the distal cap is substantially the same color as the lighting of the light emitting diode strip.

14. The device of claim 1, wherein the battery comprises 3 AAA batteries.

15. The device of claim 1, wherein the control portion is disposed to position on the proximal cap.

16. The device of claim 1, further including a flexible stand, the flexible stand defined by a base and a sleeve, the base configured to support the tube, the sleeve configured to detachably attach to the distal end or the proximal end of the tube, the sleeve further configured to enable a swaying motion by the tube.

17. The device of claim 16, wherein the base of the flexible stand is a suction cup.

18. The device of claim 1, wherein the battery housing is aluminum alloy that is waterproof and resists oxidation.

19. A flexible illumination device for environmentally friendly signaling, the device comprising:
a light emitting diode strip, the light emitting diode strip configured to selectively illuminate in a steady lighting pattern and an alternating lighting pattern;
a generally elongated tube, the tube defined by a distal end and a proximal end, the tube configured to encapsulate the light emitting diode strip, the tube further configured to enable the lighting patterns from the light emitting diode strip to at least partially pass through, the tube further configured to at least partially bend;
a reflector cap, the reflector cap configured to at least partially scatter the lighting patterns;
a battery housing, the battery housing configured to contain a battery, the battery housing further configured to restrict moisture from engaging the battery;
a distal cap, the distal cap disposed to cover the distal end of the tube, the distal cap comprising a foam composition, the distal cap further configured to form a water tight seal over the distal end of the tube;
a proximal cap, the proximal cap disposed to cover the proximal end of the tube, the proximal cap further configured to form a water tight seal over the proximal end of the tube;
a control portion, the control portion configured to operatively connect to the light emitting diode strip and the battery, the control portion comprising a power switch and a lighting switch, the power switch configured to power on and power off the light emitting diode switch, the lighting switch configured to selectively alternate between the steady lighting pattern and the alternating lighting pattern;
an outer grip, the outer grip configured to at least partially wrap around a portion of the tube, the outer grip configured to facilitate gripping the device; and
a flexible stand, the flexible stand defined by a base and a sleeve, the base configured to support the tube, the sleeve configured to detachably attach to the distal end or the proximal end of the tube, the sleeve further configured to enable a swaying motion by the tube.

20. A flexible illumination device for environmentally friendly signaling, the device comprising:
a plurality of one Watt light emitting diode lamps, the plurality of one Watt light emitting diode lamps configured to selectively illuminate in a steady lighting pattern and an alternating lighting pattern, the plurality of one Watt light emitting diode lamps configured to generate about 360 lumens;
a generally elongated tube, the tube defined by an open distal end and an open proximal end, the tube configured to encapsulate the plurality of one Watt light emitting diode lamps, the tube further configured to enable the lighting patterns to at least partially pass through, the tube further configured to at least partially bend;
a reflector cap, the reflector cap configured to at least partially scatter the lighting patterns;
a battery housing, the battery housing configured to contain a battery, the battery housing further configured to restrict moisture from engaging the battery, the battery comprising three AAA batteries;
a distal cap, the distal cap disposed to cover the distal end of the tube, the distal cap comprising a foam composition, the distal cap further configured to form a water tight seal over the distal end of the tube;
a proximal cap, the proximal cap disposed to cover the proximal end of the tube, the proximal cap further configured to form a water tight seal over the proximal end of the tube;
a control portion, the control portion configured to operatively connect to the light emitting diode strip and the battery, the control portion comprising a power switch and a lighting switch, the power switch configured to power on and power off the light emitting diode switch, the lighting switch configured to selectively alternate between the steady lighting pattern and the alternating lighting pattern, the lighting switch further configured to enable alternating of the lighting patterns between three different colors;
an outer grip, the outer grip configured to at least partially wrap around a portion of the tube, the outer grip configured to facilitate gripping the device, the outer grip comprising a substantially foam material composition; and
a flexible stand, the flexible stand defined by a base and a sleeve, the base configured to support the tube, the sleeve configured to detachably attach to the distal end or the proximal end of the tube, the sleeve further configured to enable a swaying motion by the tube.
